(19) United States
(12) Patent Application Publication
(10) Pub. No.: US 2023/0316177 A1
(43) Pub. Date: Oct. 5, 2023

(54) METHOD FOR PRIORITIZING AGENTS FOR WORKING FROM OFFICE VIA A WFM APPLICATION IN A HYBRID CONTACT CENTER WORK ENVIRONMENT

(71) Applicant: NICE LTD., Ra'anana (IL)

(72) Inventors: Pramod GIRI, Pune (IN); Salil DHAWAN, Pune (IN); Swati KADU, Pune (IN)

(21) Appl. No.: 18/205,541

(22) Filed: Jun. 4, 2023

Related U.S. Application Data
(63) Continuation-in-part of application No. 17/571,490, filed on Jan. 9, 2022.

(51) Int. Cl. G06Q 10/0631; G06Q 10/0639; G06Q 10/04

(52) U.S. Cl. CPC G06Q 10/063112; G06Q 10/06393; G06Q 10/04

(57) ABSTRACT

A computerized-method for prioritizing agents for working from office via a WFM application, in a hybrid-contact-center work environment. The computerized-method includes: when creating a schedule for a period via the WFM application: getting skills for each day in the schedule, each skill having an associated priority; and allocating agents for each skill in descending order of priority associated to the skill by: for each skill that requires agents to work from office: getting forecast agents count for the skill; and allocating agents to office location based on office capacity and a calculated Agent Work From Office (AWFO) score in ascending order and Agent Health (AH) score greater than ‘0’ until office capacity is full or agent requirements for the skill are fulfilled; when the agents count for the skill is not fulfilled, allocating agents to work from home based on an associated Agent Home Productivity (AHP) score in descending order.

### RELATED APPLICATIONS

This application claims priority as a continuation-in-part of U.S. application Ser. No. 17/571,490 dated Jan. 9, 2022, the disclosure of which is incorporated herein by reference in its entirety.

### TECHNICAL FIELD

The present disclosure relates to the field of data analysis and more specifically to prioritizing agents for working from office, in a hybrid contact center work environment.

### BACKGROUND

Due to pandemic like situations, contact centers have to adapt to a hybrid work culture and agents should be prepared and equipped to work from office as well as to work from Home. However, the change in work environment should be controlled and balanced so that agent's Key Performance Indicator (KPI)s and customer experience would not deteriorate.

From the aspect of workforce management, agents which are scheduled to work from office, have to adhere to the organization and government rules and regulations. These agents may be also relatively less productive while working from home than while working from office. While working from home there are many factors which reduce or enhance performance of an agent while interacting with a customer. These factors may reflect on the agent KPIs, as the KPI's get deviated from average values.

Certain skills where the office set-up is equipped better to handle the interactions have to be considered. Skills which are more applicable to office environment may be for example, conducting video calls with customers, where the quality of network may be better as well as the set-up, handling security issues for organizations, such as banks and the like. Hence, skills which require work from office to better handle interactions from both the aspect of agent performance and the aspect of the interaction quality have to be considered. There are also work-related situations which require work from office. For example, trainee agents who need an in-person support and guidance.

Therefore, there is a need for a technical solution to optimize the right home-office mix for each agent as well as for each shift in a contact center, by taking into account factors, such as agent's performance, skills which are more applicable to office environment in addition to one's personal preference to work from office or home.

In other words, there is a need for a technical solution that will prioritize agents for working from office, in a hybrid contact center work environment, thus, providing an appropriate agent mix as regards to working from home or office, which eventually will enhance the contact center productivity while taking into account agent preferences in the process.

### SUMMARY

There is thus provided, in accordance with some embodiments of the present disclosure, a computerized-method for prioritizing agents for working from office via a Work Force Management application, in a hybrid contact center work environment.

Furthermore, in accordance with some embodiments of the present disclosure, when creating a schedule for a period, via the Work Force Management (WFM) application: getting one or more skills for each day in the schedule, each skill having an associated priority; allocating agents for each skill in descending order of priority associated to the skill by: for each skill that requires agents to work from office: a. getting forecast agents count for the skill: b. allocating agents to office location based on office capacity and a calculated Agent Work From Office (AWFO) score in ascending order and Agent Health (AH) score greater than ‘0’ until office capacity is full or agent requirements for the skill are fulfilled; when the agents count for the skill is not fulfilled, allocating agents to work from home based on an associated Agent Home Productivity (AHP) score in descending order.

Furthermore, in accordance with some embodiments of the present disclosure, when the skill doesn't require agents to work from office allocating agents to work from home based on associated Agent Home Productivity (AHP) score in descending order; The AWFO score and the AHP score may be calculated by operating an Agent Work From Office (AWFO) Prioritization Analytics module.

Furthermore, in accordance with some embodiments of the present disclosure, the AWFO Prioritization Analytics module may include for each agent in the data store of agents' metrics: calculating an Agent Health (AH) score; when the AH score is ‘1’ then: calculating: (i) Agent Home Productivity (AHP) score; (ii) Agent Skills Prioritization (ASP) score; and (iii) agent's preferences to work from office indicator; and determining an AWFO score based on the AHP score, the ASP score and the agent's preferences to work from office indicator.

Furthermore, in accordance with some embodiments of the present disclosure, the AWFO Prioritization Analytics module may include for each agent in the data store of agents' metrics calculating an Agent Health (AH) score.

Furthermore, in accordance with some embodiments of the present disclosure, when the AH score is ‘1’ then calculating: (i) Agent Home Productivity (AHP) score: (ii) Agent Skills Prioritization (ASP) score; and (iii) agent's preferences to work from office indicator: determining an AWFO score based on the AHP score, the ASP score and the agent's preferences to work from office indicator.

Furthermore, in accordance with some embodiments of the present disclosure, the calculating of the AH score may be operated by retrieving agent's health metrics from the data store of agents' metrics and comparing with government and organization rules and regulations.

Furthermore, in accordance with some embodiments of the present disclosure, the calculating of AHP score may be operated by summing a preconfigured one or more agent Key Performance Indicator (KPI) scores, each KPI is per skill of the agent.

Furthermore, in accordance with some embodiments of the present disclosure, the one or more agent KPIs may be calculated per skill based on formula I:

Agent KPI score=(Agent KPI−Minimum KPI)/(Maximum KPI−Minimum KPI), (I)

whereby:
Agent KPI is agent KPI score per skill during work from home,
Minimum KPI is a minimum KPI score per skill during work from home of all agents having same skills as the agent, and Maximum KPI is a maximum KPI score per skill during work from home of all agents having same skills as the agent.

Furthermore, in accordance with some embodiments of the present disclosure, the calculating of ASP score may be operated by counting a number of agent skills that have been attributed as work from office of the agent.

Furthermore, in accordance with some embodiments of the present disclosure, the calculating of agent's preferences to work from office indicator may be when the AHP score is above a preconfigured threshold.

Furthermore, in accordance with some embodiments of the present disclosure, the AWFO score may be determined by formula II:

AWFO Score=W₁*AHP score−W₂*ASP score−W₃*Agent preference to work from home indicator*Counter (II)

whereby,
counter is a preconfigured value, and
W₁, W₂, W₃ are preconfigured weights.

Furthermore, in accordance with some embodiments of the present disclosure, after an agent is selected to work from office the agent's preferences to work from office indicator may be reset to zero to ensure rotational basis of agents.

### BRIEF DESCRIPTION OF THE DRAWINGS

FIG. 1A schematically illustrates a high-level diagram of a system for prioritizing agents via a Work Force Management application for working from office, in a hybrid contact center work environment, in accordance with some embodiments of the present disclosure;

FIGS. 1B-IC are a high-level workflow of computerized-method for prioritizing agents for working from office via a Work Force Management application, in a hybrid contact center work environment, in accordance with some embodiments of the present disclosure;

FIG. 2 is a high-level workflow of an Agent Work From Office (AWFO) Prioritization Analytics module, in accordance with some embodiments of the present disclosure;

FIG. 3 illustrate an example of a calculation of Agent Home Productivity (AHP) score, in accordance with some embodiments of the present disclosure:

FIG. 4 shows an example of a list of prioritized agents for working from office presented via a Workforce Management (WFM) User Interface (UI), in accordance with some embodiments of the present disclosure;

FIG. 5 illustrates an example a calculation of Agent Home Productivity (AHP) score, in accordance with some embodiments of the present disclosure:

FIG. 6 illustrates an example of agent's health check questionnaire, in accordance with some embodiments of the present disclosure;

FIGS. 7A-7K show examples of details of contact center schedule workforce management in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “hybrid contact center work environment” as used herein refers to a work environment that includes work from home and from office or regional hubs for each employee. In every scheduled shift there may be employees working in all types of locations: home, office and regional hubs.

The term “office” as used herein refers to a location where agents are working from, which may include regional hubs.

54% of contact centers post pandemic will operate on a hybrid model where staff is supported from home and the office or regional hubs. As of early 2021, 63% of contact centers operate on a hybrid model, while less than one third (29%) remain fully remote. Once vaccines are widely available, though, only 7% plan to remain fully remote while the vast majority plan to continue on with a hybrid model of work environment. Instead of remaining fully remote, many people will be working from home and the office, particularly because 75% of brands say that compliance and protecting customer data remotely is still a concern.

According to Frost and Sullivan, a research and consulting firm, the retention rate for at-home agents is 80% vs. 25% for in-house. A hybrid work culture becomes more common and contact centers have to incorporate this culture while handling workforce management. Moreover, since agent productivity and health are dynamic and change over time, there is a need for a technical solution that will enable rotation of agents, such that all healthy agents can contribute effectively towards a hybrid work culture.

Accordingly, there is a need for a system and method for prioritizing agents for working from office, in a hybrid contact center work environment.

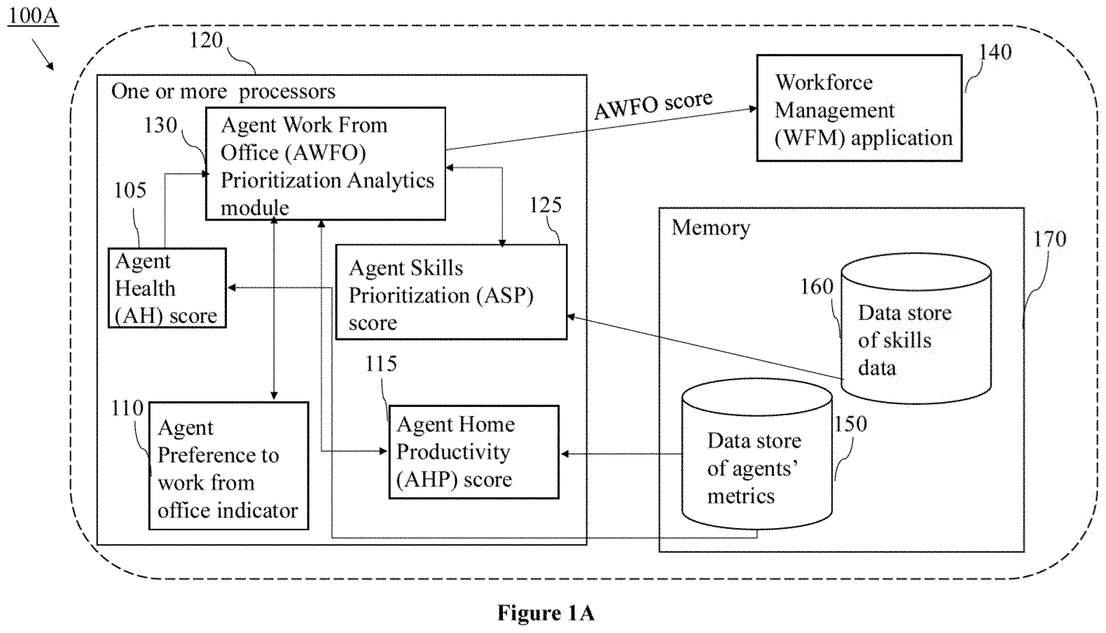

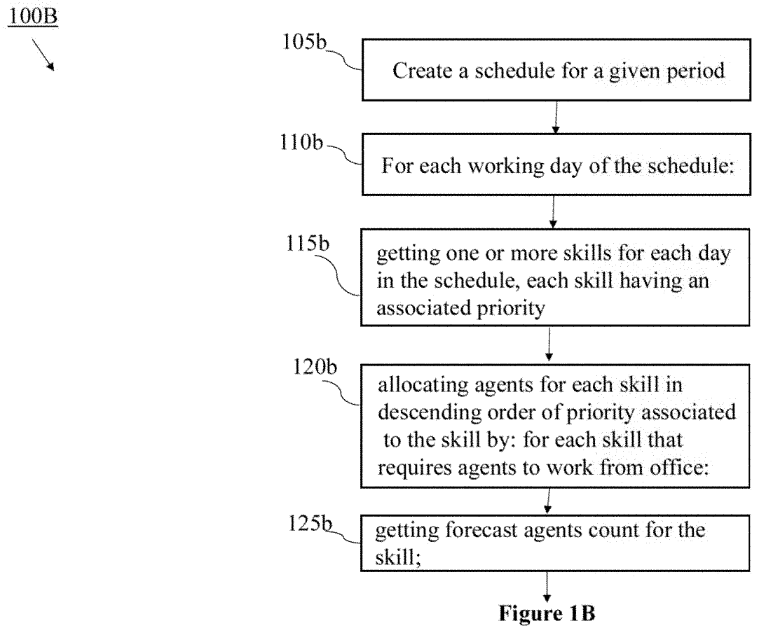

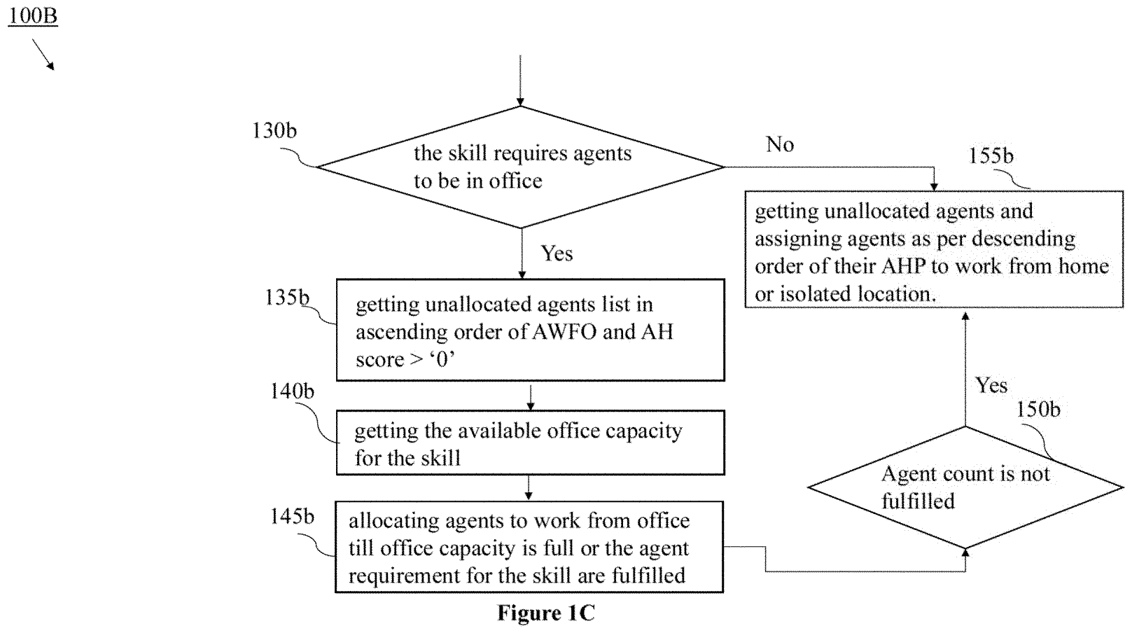

FIG. 1A schematically illustrates a high-level diagram of a system 100 for prioritizing agents for working from office via a Work Force Management (WFM) application, in a hybrid contact center work environment, in accordance with some embodiments of the present disclosure.

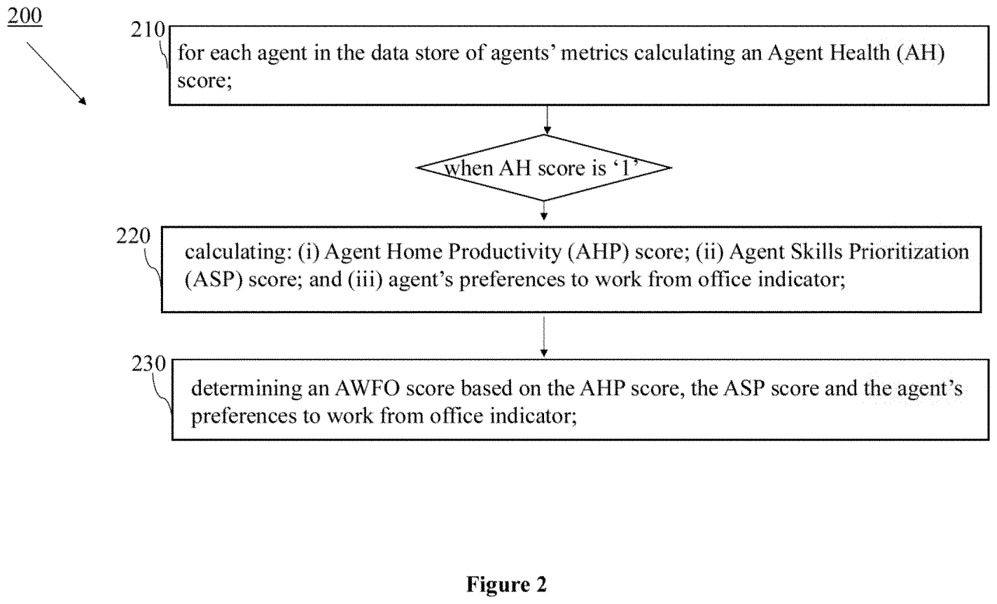

According to some embodiments of the present disclosure, a computerized-system such as system 100, may include one or more processors 120, and a memory 170 including a data store of skills data 160, and a data store of agents' metrics 150. The one or more processors 120 may operate a module such as an Agent Work From Office (AWFO) Prioritization Analytics module 130 and such as Agent Work From Office (AWFO) Prioritization Analytics module 200 in FIG. 2.

According to some embodiments of the present disclosure, due to pandemic situations which require a hybrid model of working from home or from office or regional hubs, it is significant to allocate the work location, e.g., home, office or regional hubs to agents as per their health state, productivity level at home, skills and work location preferences via an application, such as WFM application 140 or any other application.

According to some embodiments of the present disclosure, for each agent in the data store of agents' metrics 150, a module, such as Agent Work From Office (AWFO) Prioritization Analytics module 130 and such as an Agent Work From Office (AWFO) Prioritization Analytics module 200 may be calculating an Agent Health (AH) score 105.

According to some embodiments of the present disclosure, the WFM application 140 may operate a computerized-method for prioritizing agents for working from office, in a hybrid contact center work environment, as shown in FIGS. 1B-1C.

According to some embodiments of the present disclosure, the WFM application 140 when creating a schedule for a period, may get one or more skills for each day in the schedule, where each skill is having an associated priority and then may allocate agents for each skill in descending order of priority associated to the skill by: for each skill that requires agents to work from office: getting forecast agents count for the skill; and then allocating agents to office location based on office capacity and a calculated Agent Work From Office (AWFO) score in ascending order and Agent Health (AH) score greater than ‘0’ until office capacity is full or agent requirements for the skill are fulfilled.

According to some embodiments of the present disclosure, the WFM application 140, when the agents count for the skill is not fulfilled, may allocate agents to work from home based on an associated Agent Home Productivity (AHP) score in descending order. When the skill doesn't require agents to work from office, allocating agents to work from home based on associated Agent Home Productivity (AHP) score in descending order.

According to some embodiments of the present disclosure, the AWFO score and the AHP score may be calculated by operating the AWFO Prioritization Analytics module 130, as shown for example, in FIG. 2. The AWFO Prioritization Analytics module 130 may include for each agent in the data store of agents' metrics 150: calculating an Agent Health (AH) score; when the AH score is ‘1’ then: calculating: (i) Agent Home Productivity (AHP) score; (ii) Agent Skills Prioritization (ASP) score; and (iii) agent's preferences to work from office indicator; and determining the AWFO score based on the AHP score, the ASP score and the agent's preferences to work from office indicator.

According to some embodiments of the present disclosure, the calculating of the AH score 105 may be operated by retrieving agent's health metrics from the data store of agents' metrics 150 and comparing with government and organization rules and regulations.

According to some embodiments of the present disclosure, the calculation of the AH score 105 may take into consideration agent's health factors and rules and regulations laid by the government. For example, if an agent is partially vaccinated and local government rules and regulations allow only fully vaccinated employees to work from office, then the agent will not be considered to work from office and the agent AH score may be ‘0’ or any other value that is not ‘1’. The calculated AH score of an agent that is fully vaccinated may be ‘1’.

According to some embodiments of the present disclosure, the calculation of the AH score may be operated based on formula III:

AH score=rating×weight (III)

whereby:
rating is ‘1’ when the agent fit to work from office as per Government and Organization rules and regulation, rating is ‘−1’ when the agent doesn't fit to work from office as per Government and Organization rules and regulation, rating is ‘0’ when the agent is not able to evaluate the required fitness criteria,
weight is a parameter that can be set to ‘0’ periodically to trigger agent health evaluations. It can be set to ‘−1’ in case the organization or the government wants to enforce work from home or isolated location for all agents.

According to some embodiments of the present disclosure, the default value of rating may be ‘−1’, which indicates a new agent that has joined and undergoes fitness test to check fitness level and only then the AH score may be evaluated.

According to some embodiments of the present disclosure, rating ‘1’ indicates that the agent can work from office health perspective wise.

According to some embodiments of the present disclosure, rating is ‘0’ indicates that the agent is not able to evaluate the required fitness criteria, then the agent may request evaluation from a supervisor. The Supervisor can request a medical certificate if required and then discuss with Human Resource (HR) department to allow work from office. In this case the value of rating may change to ‘1’.

According to some embodiments of the present disclosure, only for employees that their AH score is ‘1’ the option of working from office may be considered, otherwise when the AH score is not ‘1’ Agent Work From Office (AWFO) score may not be applicable and these employees may be scheduled to work from home only.

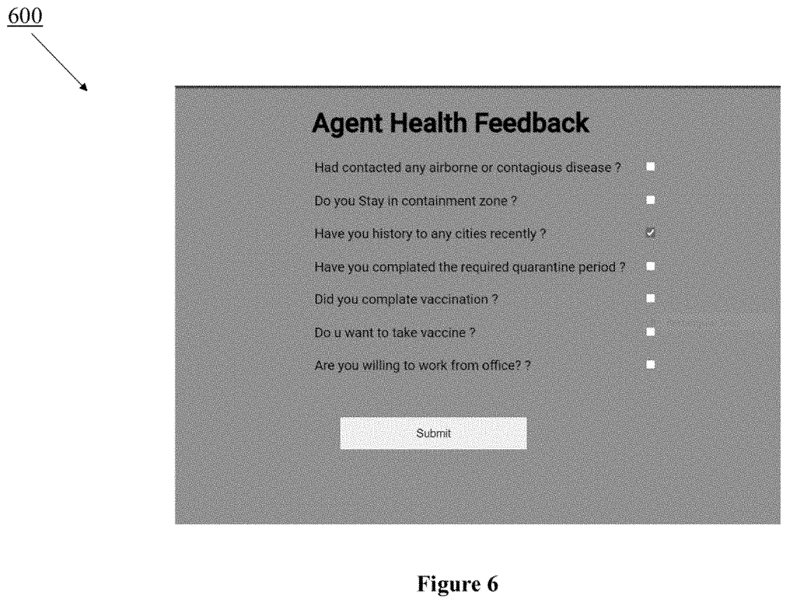

According to some embodiments of the present disclosure, when the AH score is ‘1’, a supervisor approval may confirm that the agent is suitable to work from office or not. A sample questionnaire is provided via the User Interface (UI) section of the WFM application 140, as shown in the example 600 of agent's health check questionnaire, in FIG. 6.

According to some embodiments of the present disclosure, agent health factor, agent productivity aspects and agents' skills may be taken into consideration, as well as agent work location preference to achieve a right agent-mix in each scheduled-shift for agents working from home or office. The agent productivity when working from home may be measured in terms of deviation from average Key Performance Indicators (KPI) scores of other agents when working from home and having the same skills. In other words, the average KPI values may be determined by the KPI data received from all work from home agents having the same skills as the agent.

According to some embodiments of the present disclosure, when the AH score of an agent is ‘1’, then the Agent Work From Office (AWFO) Prioritization Analytics module 130 may calculate: (i) Agent Home Productivity (AHP) score; (ii) Agent Skills Prioritization (ASP) score; and (iii) agent's preferences to work from office indicator.

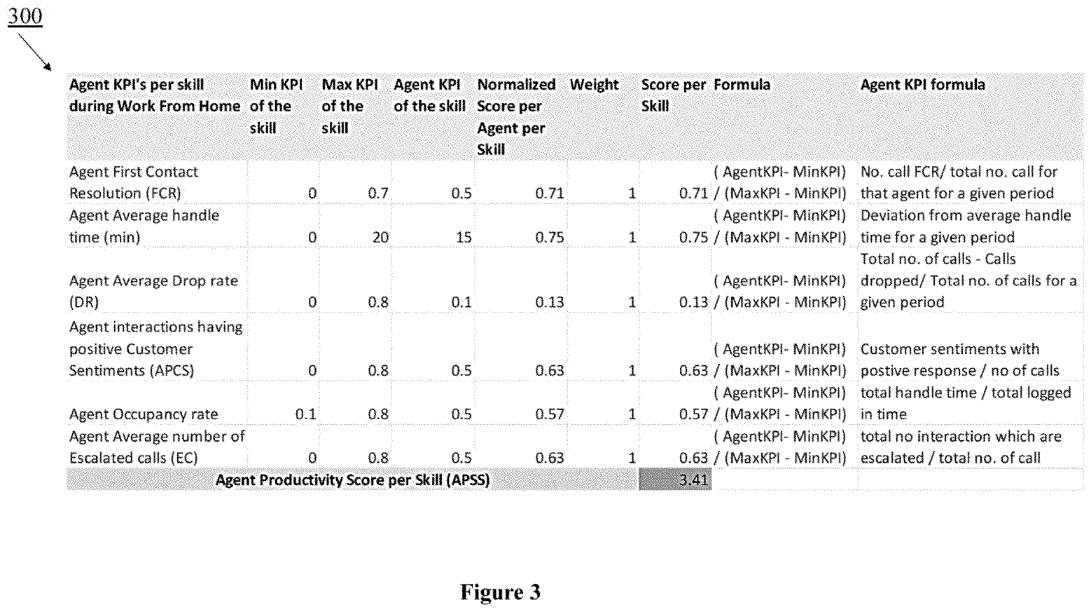

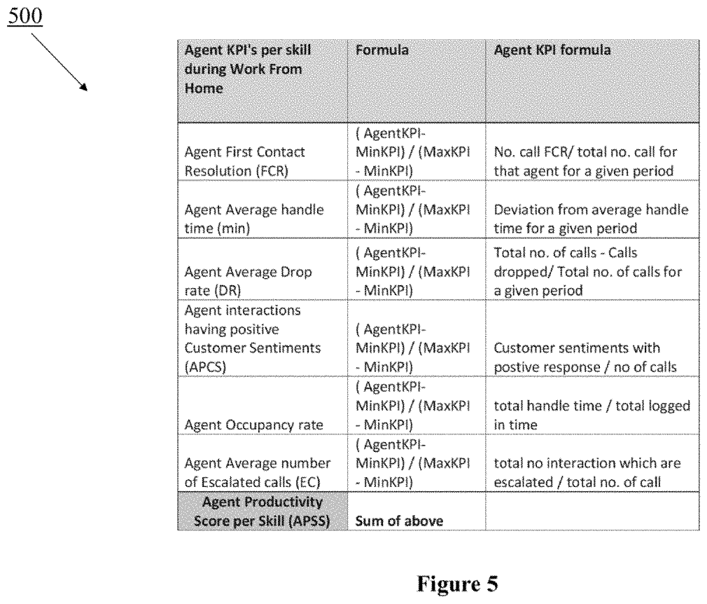

According to some embodiments of the present disclosure, the calculating of AHP score 115 may be operated by summing a preconfigured one or more agent Key Performance Indicator (KPI) scores. Each KPI is per skill of the agent. For example, as shown in example 300 of a calculation of Agent Skills Prioritization (AHP) score in FIG. 3 and example 500, in FIG. 5.

According to some embodiments of the present disclosure, the one or more agent KPIs scores may be calculated per skill based on formula I:

Agent KPI score=(Agent KPI−Minimum KPI)/(Maximum KPI−Minimum KPI), (I)

whereby:
Agent KPI is an agent KPI score per skill during work from home,
Minimum KPI is a minimum KPI score of all agents having same skills as the agent and working from home, and Maximum KPI is a maximum KPI score of all agents having same skills as the agent and working from home.

According to some embodiments of the present disclosure, the one or more agent KPIs may be calculated per skill based on formula I, as shown in example 500 of a calculation of Agent Home Productivity (AHP) score, in FIG. 5.

According to some embodiments of the present disclosure, the calculating of agent's preferences to work from office indicator is when the AHP score is above a preconfigured threshold. Which means that the agent's location preferences may be taken into account only when the agent's home productivity is above a preconfigured threshold.

According to some embodiments of the present disclosure, determining an AWFO score based on the AHP score 115, the ASP score 125 and the agent's preferences to work from office indicator. The agent's preferences to work from office indicator is ‘1’ when the agent prefers to work from the office.

According to some embodiments of the present disclosure, the AWFO score may be determined by formula II:

AWFO Score=W₁*AHP score−W₂*ASP score−W₃*Agent preference to work from home indicator*Counter (II)

whereby,
counter is a preconfigured value, and
W₁, W₂, W₃ are preconfigured weights.

According to some embodiments of the present disclosure, the preconfigured value of the counter may be ‘0.5’.

According to some embodiments of the present disclosure, when the agent preference to work from home indicator is ‘1’ the counter may increment every preconfigured period until the agent is selected for work from the office. Once the agent has been scheduled to work from office counter may reset to ‘0’ to ensure that agents with high level of productivity who are willing to come to office are called to work from office, on rotational basis.

According to some embodiments of the present disclosure, the calculating of ASP score 125 may be operated by counting the number of agent skills that have been attributed as work from office.

According to some embodiments of the present disclosure, after an agent is selected to work from office via a UI of the WFM application 140, the agent's preferences to work from office indicator may be reset to zero to ensure rotational basis of agents. Thus, enabling the contact center to maintain a high level of agent motivation, customer satisfaction and at the same time optimizing contact center productivity in a hybrid work model.

According to some embodiments of the present disclosure, the Agent Work From Office (AWFO) Prioritization Analytics module 130 may send the determined AWFO score to an application such as the WFM application 140 to be presented via a User Interface (UI) thereof. For example, as shown by example 400 of a list of prioritized agents for working from office presented via a Workforce Management (WFM) User Interface (UI).

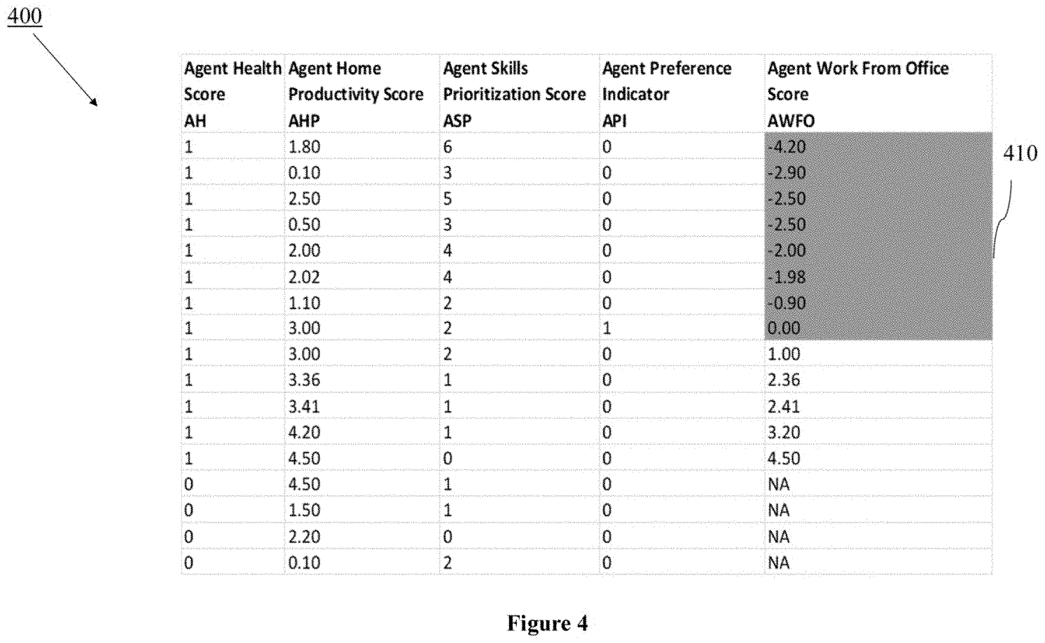

According to some embodiments of the present disclosure, optionally, a preconfigured number of agents to work from office may be selected from the agents having the lowest AWFO score as shown in the list 410 in FIG. 4. 7. Remaining agents which are required for a scheduled shift that were not selected to work from office may be considered for work from home. Optionally, Agents having an AWFO score higher than zero may not be selected to work from office due to a predetermined quota to work from office during a shift. These agents may be stored in a buffer pool for situations such as backup agents when other agents may be absent end the like.

FIGS. 1B-1C are a high-level workflow of computerized-method for prioritizing agents for working from office via a Work Force Management application, in a hybrid contact center work environment, in accordance with some embodiments of the present disclosure.

According to some embodiments of the present disclosure, a WFM application, such as WFM application 140 in FIG. 1A may use schedule forecasting where the optimum number of agent count is forecasted to meet the contact center requirement for each day. The forecasting may be operated by various standard techniques, such as taking average skill requirement per week of day and adding some buffer count. In special seasons such as during festival season, like black Friday or any campaign or event, the forecasting may be operated by referring to past data during those events.

According to some embodiments of the present disclosure, based on the forecasting the count of agent per skill information may be available for each schedule. In a hybrid work environment, many a times there is a requirement that certain skills or agents has to work from office. Due to pandemic like situation organization and/or government can take a call to restrict the number of people coming to office. In other situations, contact centers may have limited seating capacity but have varying number of agents so they cannot accommodate all the agents in office, therefore there is a need for a technical solution to manage such workforce.

According to some embodiments of the present disclosure, when an agent is having an AH score ‘1’, then the agent may be considered eligible to work from office by the WFM application. When the AH score is zero, then such agents will not be considered for workforce management till a user, such as a supervisor, approves them to be eligible for work from home or office and set the corresponding AH score value to either positive value, i.e., eligible to work from office or negative i.e., eligible to work from home. By default, if the AH score is not available then it may be considered as −1, i.e., agent will be considered for work from home till the score is available.

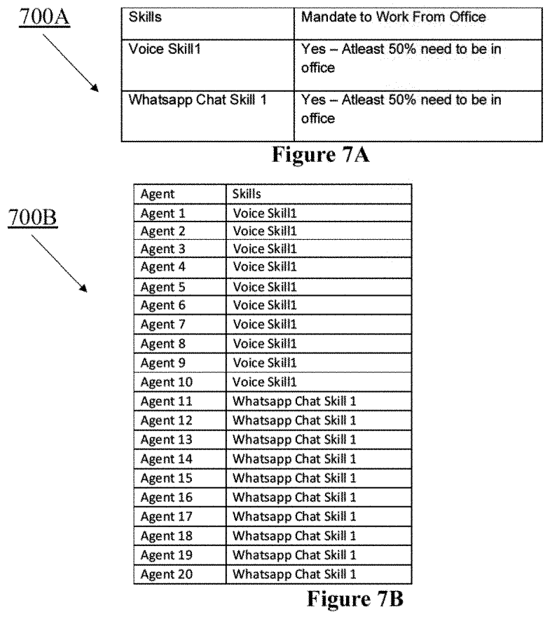

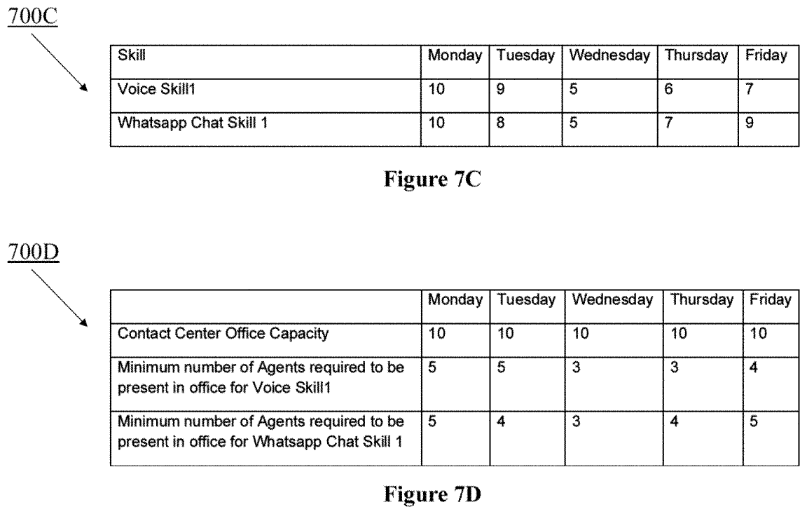

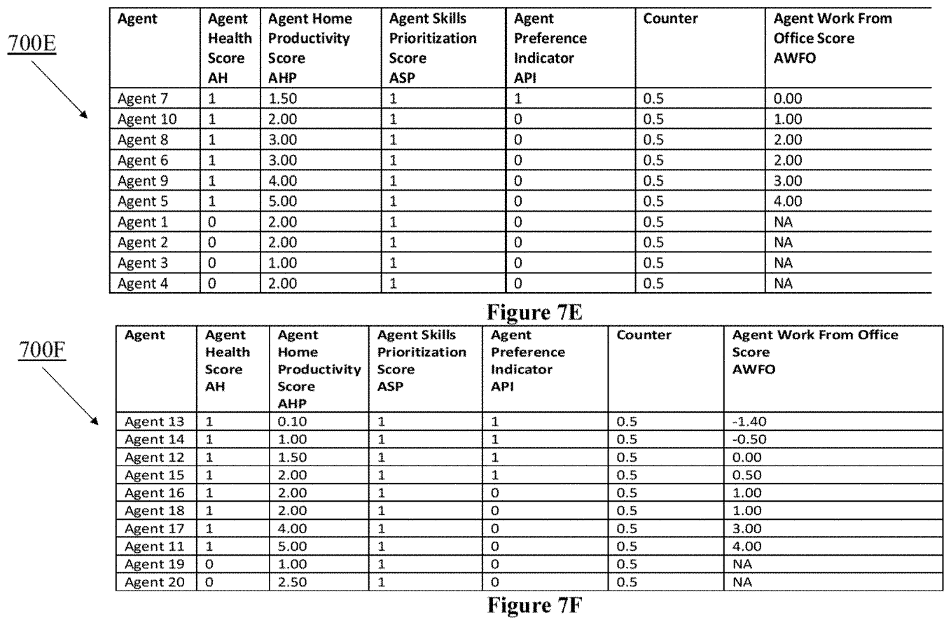

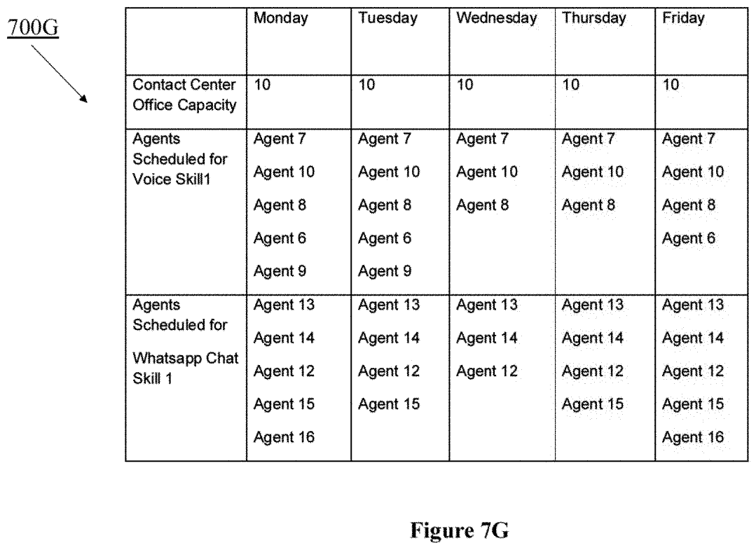

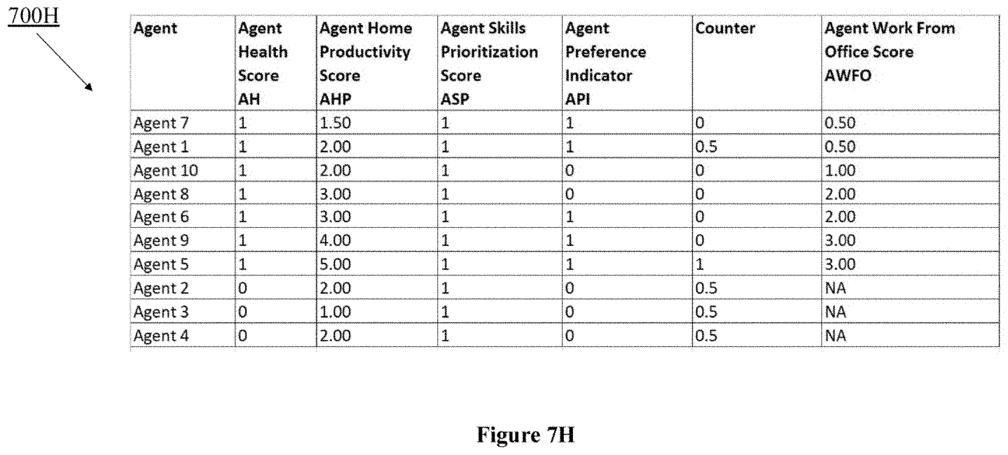

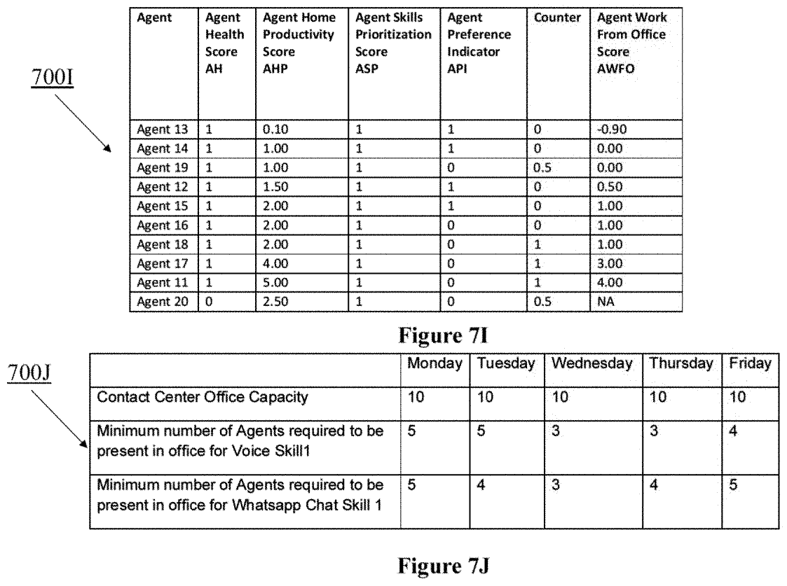

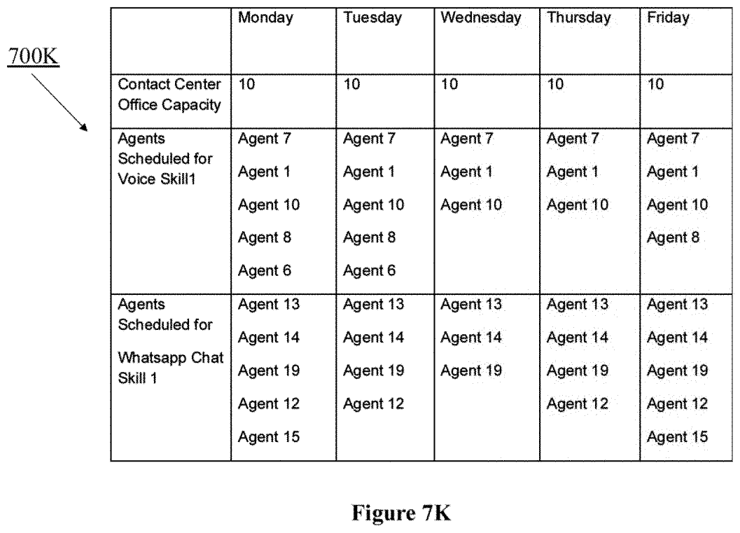

According to some embodiments of the present disclosure, when there is more than one skill which mandates agents to come to office, for example, as shown in table 700A in FIG. 7A, then the contact center may decide which skill to give preference to or define a ratio of seating capacity for the required skill allocations. For example, 20% of capacity available to ‘skill 1’ and 80% capacity available to ‘skill 2’.

According to some embodiments of the present disclosure, the capacity allocation may be defined across offices in case a contact center has multiple office locations. For example, ‘office 1’ may hold x % of ‘skill 1’ capacity and ‘office 2’ may hold y % of ‘skill 1’ capacity. Allocations may also be operated based on agents office location preference, so if maximum agents prefer a location, it can be defined to have more capacity for that skill.

According to some embodiments of the present disclosure, in case of more than required capacity of agents working from home, then work from home agents can be selected based on their productivity at home. Descending order of AHP may be used to select agents working from home.

According to some embodiments of the present disclosure, a WFM application, such as WFM application 140, in FIG. 1A, may be operated to create a schedule for a given period 105b. For each working day of the schedule 110b, getting one or more skills for each day in the schedule, each skill having an associated priority 115b. The skill having highest priority will be first to be allocated agents. allocating agents for each skill in descending order of priority associated to the skill by: for each skill that requires agents to work from office 120b: getting forecast agents count for the skill 125b.

According to some embodiments of the present disclosure, checking if the skill requires agents to be in office 130b. If the skill requires agents in the office, then getting unallocated agents list in ascending order of AWFO and AH score >‘0’ 135b.

According to some embodiments of the present disclosure, getting the available office capacity for the skill 140b and then allocating agents to work from office, till office capacity is full or the agent requirement for the skill are fulfilled 145b. The agents may be allocated in ascending order of AWFO and AH score >‘0’

According to some embodiments of the present disclosure, when agent count is not fulfilled 150b, then getting unallocated agents and assigning agents as per descending order of their AHP to work from home or isolated location 155b.

According to some embodiments of the present disclosure, when the skill doesn't require agents to be in office then, getting unallocated agents and assign agents as per descending order of their AHP to work from home or isolated location 155b.

FIG. 2 is a high-level workflow of an Agent Work From Office (AWFO) Prioritization Analytics module 200, in accordance with some embodiments of the present disclosure.

According to some embodiments of the present disclosure, operation 210 may comprise for each agent in the data store of agents' metrics calculating an Agent Health (AH) score.

According to some embodiments of the present disclosure, when the AH score is ‘1’ then operation 220 may comprise calculating: (i) Agent Home Productivity (AHP) score: (ii) Agent Skills Prioritization (ASP) score; and (iii) agent's preferences to work from office indicator.

According to some embodiments of the present disclosure, operation 230 may comprise determining an AWFO score based on the AHP score, the ASP score and the agent's preferences to work from office indicator.

FIG. 3 illustrate an example 300 of a calculation of Agent Home Productivity (AHP) score, in accordance with some embodiments of the present disclosure.

According to some embodiments of the present disclosure, the one or more agent Key Performance Indicator (KPI)s may be for example, Agent First Contact Resolution (FCR), Agent Average handle time (mm), Agent Average Drop rate (DR), Agent interactions having positive customer Sentiments (APCS), Agent Occupancy rate, Agent Average number of Escalated calls (EC) and the like.

According to some embodiments of the present disclosure, to calculate each KPI of each skill a minimum KPI of all agents having same skills as the agent which are working from home may be retrieved, a maximum KPI of all agents having same skills as the agent which are working from home may be retrieved and the Agent KPI. The one or more agent KPIs scores may be calculated per skill based on formula I, as shown in example 500 in FIG. 5:

Agent KPI score=(Agent KPI−Minimum KPI)/(Maximum KPI−Minimum KPI), (I)

whereby:
Agent KPI is agent KPI per skill during work from home,
Minimum KPI is a minimum KPI score per skill during work from home of all agents having same skills as the agent, and Maximum KPI is a maximum KPI score per skill during work from home of all agents having same skills as the agent.

According to some embodiments of the present disclosure, each KPI may be calculated based on a formula. For example, Agent First Contact Resolution (FCR) may be calculated by the following formula: No. call FCR/total no. call for that agent for a given period. In another example, Agent Average handle time (min) may be calculated by the following formula: Deviation from average handle time for a given period. In yet another example, Agent Average Drop rate (DR) may be calculated based on the formula: total no. of calls−calls dropped/total no. of calls for a given period.

According to some embodiments of the present disclosure, the Agent Home Productivity (AHP) score may be calculated by summing a preconfigured one or more agent Key Performance Indicator (KPI) scores. Each KPI is per skill of the agent. In example 300 of a calculation of Agent Home Productivity (AHP)score the AHP score is 3.41 which is a sum of KPI score of FCR 0.71, KPI score of Agent Average handle time 0.75, KPI score of Agent Average Drop rate 0.13, KPI score of Agent interactions having positive customer sentiments 0.63, KPI score of agent Occupancy rate 0.57 and KPI score of Agent Average number of Escalated calls (EC) 0.63.

FIG. 4 shows an example 400 of a list of prioritized agents for working from office presented via a Workforce Management (WFM) User Interface (UI), in accordance with some embodiments of the present disclosure.

According to some embodiments of the present disclosure, a preconfigured number of agents to work from office may be selected from agents having a lowest Agent Work From Office (AWFO) score. For example, as shown in example 400, agents having the lowest scores 410 may be presented via a UI of an application, such as WFM application 140 in FIG. 1 and may be selected to work from the office.

According to some embodiments of the present disclosure, the AWFO score may be not applicable when the AH score of the agent is not ‘1’. Agents which may not be selected to work from the office may have AWFO scores higher than ‘0’. Meaning, even though agents having a AWFO score higher than zero they may not be selected to work from office and may be stored in a buffer pool for later on scheduled shifts.

FIGS. 7A-7K show examples of details of contact center schedule workforce management in accordance with some embodiments of the present disclosure.

According to some embodiments of the present disclosure, the implementation of computerized-method for prioritizing agents for working from office via a Work Force Management application, in a hybrid contact center work environment by WFM 140 in FIG. 1A may be demonstrated by a contact center having a schedule which requires two skills each. Both skills may be required to be performed from office as its seen that some agents are not able to perform well on these skills when working from home setup.

According to some embodiments of the present disclosure, table 700A shows an example of two such skills, e.g., voice and Whatsapp chat. One of the skills may have a higher priority, e.g., voice skill 1 over Whatsapp chat skill, as it seen that customer satisfaction ratio is less for voice skill 1. The contact center may use different parameters to prioritize one skill over the other or have different capacities allocated per skill.

According to some embodiments of the present disclosure, table 700B is an example of skills allocation representation.

According to some embodiments of the present disclosure, table 700C is an example of two weeks of agent requirement forecasting where Saturday and Sunday are not working days in the contact center.

According to some embodiments of the present disclosure, table 700D is an example of the contact center office setup having seating capacities available for the schedule. According to the example, only ten agents can work in the office each day.

According to some embodiments of the present disclosure, tables 700E is an example of workforce management schedule for one week for voice skill based on the agent AWFO score for voice skill 1 at time of scheduling of Week 1. According to the example in table 700E, agents 1, 2, 3, 4 are not eligible to work from office due to their low health scores, e.g., AH score is ‘0’. Out of the remaining agents as per ascending order of AWFO scores agents for voice skill 1 may be scheduled by WFM application, such as WFM application 140, to work from office. To cater to the at least 50% agent mandate in office, the contact center needs to have at least 5 agents coming to office to suffice the requirement.

According to some embodiments of the present disclosure, table 700F is an example of workforce management schedule for one week for Whatsapp chat skill based on the agent AWFO score for Whatsapp chat skill at time of scheduling of Week 1. Agents 19 and 20 are not eligible to come to office due to low health scores.

According to some embodiments of the present disclosure, table 700G is an example of Week 1 schedule for agents who need to work from office. As shown in table 700G the contact center has still some capacity left and can be utilized for one or more requirements. For example, to add more agents for a specific skill that has higher priority and fill in the capacity, to allow to book seats on first come first serve basis to agents willing to work from office, and to use capacity to train agents on that particular skill. It is up to the contact center discretion to utilize the additional capacity.

According to some embodiments of the present disclosure, for week 2 workforce management as shown in the 700H, agent 1 has recovered from health issues and is now eligible to work from office. The counter value starts from 0.5. Agents who attended office in week 1 have their counter reset to 0. And those that did not attend office have their counter incremented by 0.5.

According to some embodiments of the present disclosure, table 700H shows the AWFO score for voice skill1 at time of scheduling of Week 2. Even though agent 7 has counter reset but since productivity at home is less the agent will have to come to office. Agent 1 has recovered and needs to be in office due to low AHP score. The WFM application 140 by operating the computerized-method for prioritizing agents for working from office via a WFM application, in a hybrid contact center work environment, as shown in FIGS. 1B-1C, ensures that the better an agent performs at home least are the chances to be called to office by encouraging to be productive at home. Furthermore, there is rotation among agents who are called to office.

According to some embodiments of the present disclosure, table 700I shows agent AWFO score for Whatsapp chat skill 1 at the time of scheduling of Week 2. Also, agent 19 has recovered from medical issues and has resumed office.

According to some embodiments of the present disclosure, table 700J shows that Week 2 forecasting of skills requirement has remained the same.

According to some embodiments of the present disclosure, table 700K shows Week 2 schedule for agents who need to work from office. By comparing the example of Week 1 schedule, as shown in table 700G in FIG. 700G and the example of Week 2 schedule, as shown in table 700J in FIG. 700J, it may be inferred that agent 5 and agent 16 who were productive at home as compared to other agents with the same skill could be scheduled to work from home and agent 1 and agent 19 who recovered but were having low performance at home as compared to other agents were called to office.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for prioritizing agents for working from office via a Work Force Management application, in a hybrid contact center work environment, the computerized-method comprising:
when creating a schedule for a period, via the WFM application:
(i) getting one or more skills for each day in the schedule, wherein each skill is having an associated priority;
(ii) allocating agents for each skill in descending order of priority associated to the skill by:
for each skill that requires agents to work from office:
a. getting forecast agents count for the skill;
b. allocating agents to office location based on office capacity and a calculated Agent Work From Office (AWFO)score in ascending order and Agent Health (AH)score greater than ‘0’ until office capacity is full or agent requirements for the skill are fulfilled; when the agents count for the skill is not fulfilled, allocating agents to work from home based on an associated Agent Home Productivity (AHP) score in descending order;
when the skill doesn't require agents to work from office, allocating agents to work from home based on the associated AHP score in descending order;
wherein the AWFO score and the AHP score are calculated by:
operating an Agent Work From Office (AWFO) Prioritization Analytics module, said AWFO Prioritization Analytics module comprising:
for each agent in the data store of agents' metrics:
calculating an Agent Health (AH) score;
when the AH score is ‘1’ then:
calculating: (i) AHP score; (ii) Agent Skills Prioritization (ASP) score; and (iii) agent's preferences to work from office indicator; and
determining an AWFO score based on the AHP score, the ASP score and the agent's preferences to work from office indicator.

2. The computerized-method of claim 1, wherein the calculating of AH score is operated by retrieving agent's health metrics from the data store of agents' metrics and comparing with government and organization rules and regulations.

3. The computerized-method of claim 1, wherein the calculating of AHP score is operated by summing a preconfigured one or more agent Key Performance Indicator (KPI)scores, wherein each KPI is per skill of the agent.

4. The computerized-method of claim 3, wherein the one or more agent KPIs are calculated per skill based on formula I:
Agent KPI score=(Agent KPI−Minimum KPI)/(Maximum KPI−Minimum KPI), (I)
whereby:
Agent KPI is an agent KPI score per skill during work from home,
Minimum KPI is a minimum KPI score of all agents having same skills as the agent, and
Maximum KPI is a maximum KPI score of all agents having same skills as the agent.

5. The computerized-method of claim 1, wherein the calculating of ASP score is operated by counting number of agent skills that have been attributed as work from office.

6. The computerized-method of claim 1, wherein the calculating of agent's preferences to work from office indicator is when the AHP score is above a preconfigured threshold.

7. The computerized-method of claim 1, wherein the AWFO score is determined by formula II:
AWFO Score=W₁*AHP score−W₂*ASP score−W₃*Agent preference to work from home indicator*Counter (II)
whereby
counter is a preconfigured value, and
W₁, W₂, W₃ are preconfigured weights.

8. The computerized-method of claim 6, wherein after an agent is selected to work from office the agent's preferences to work from office indicator is reset to zero to ensure rotational basis of agents.
